(19) United States
(12) Patent Application Publication
(10) Pub. No.: US 2006/0133070 A1
(43) Pub. Date: Jun. 22, 2006

(54) Flashlight hat clip

(76) Inventor: Ken Brown JR., Downingtown, PA (US)

Correspondence Address: The Law Office of Anthony R. Carlis, Suite 1D, 110 Hopewell Road, Downigtown, PA, 19335, US

(21) Appl. No.: 11/311,296

(22) Filed: Dec. 19, 2005

Related U.S. Application Data
(60) Provisional application No. 60/636,905, filed on Dec. 18, 2004.

(51) Int. Cl. F21V 21/084

(52) U.S. Cl. 362/106

(57) ABSTRACT

An improved flashlight clothing or hat attachment device comprising an attachment means which is engagable and attachable with the edge of a hat or user's clothing. The device has a first attachment member which is engagable with the user's hat or clothing to firmly position said device and flashlight between a first curved attachment member of the attachment device which is also user releasable.

### CROSS REFERENCE TO RELATED APPLICATION

This application claims priority from U.S. provisional application no. 60/636,905 which was filed on Dec. 17, 2004, which is incorporated by reference as if fully set forth.

### BACKGROUND OF THE INVENTION

Flashlights have long been popular as portable light sources. Flashlights are compact, light weight and easy to manipulate to enable the user to aim the light in a desired direction. The newer light emitting diode (LED) flashlights afford the user many hours of continued service on one set of batteries. However, one disadvantage of flashlights has been the fact that they are not self-supporting or self-positioning. In other words, it is generally necessary for the user to hold the flashlight in one hand in order to carry or aim the flashlight. If the flashlight must be carried for an extended time, it can become an arduous task. Moreover, if the user needs to use both hands for carrying other items or for performing a desired task, he may not have a hand free to carry or aim the flashlight. Therefore, what is needed is a universal flashlight clip that attaches to the user's clothing or hat to hold a flashlight, freeing up the users hands to perform other tasks.

### SUMMARY

An improved flashlight clothing or hat attachment device comprising an attachment means which is engagable and attachable with the edge of a hat or user's clothing. The device has a first attachment member which is engagable with the user's hat or clothing to firmly position said device and flashlight between a first curved attachment member of the attachment device which is also user releasable.

### BRIEF DESCRIPTION OF THE DRAWING

FIG. 1 is an example of the present invention.

### DETAILED DESCRIPTION OF THE PREFERRED EMBODIMENTS

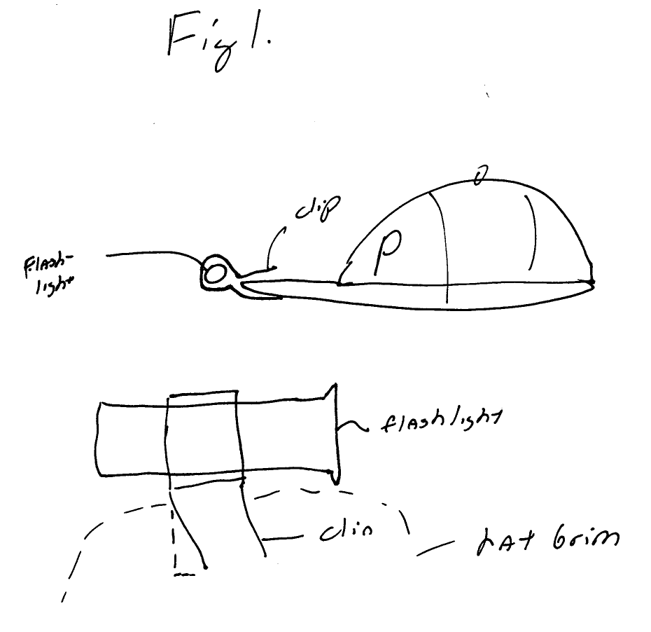

A first embodiment of the preset invention is illustrated in FIG. 1. A flashlight is held to a hat by using the present invention, a spring clip device. The spring clip holds the flashlight firmly to the hat while holding the clip itself and the flashlight firmly to the hat.

The present invention can be coated with a rubber or silicon coating to increase the friction of the clip which aids in the clips flashlight retaining properties. The coating also prevents the flashlight from spinning along its radial axis.

In a second embodiment the clip is modified somewhat and is therefore attachable to the user's clothing.

What is claimed is:

1. A spring clip device which holds a flashlight firmly to the hat, comprising an “R” shaped spring clip for holding a flashing and attaching the flashlight firmly to the hat.

2. The spring clip device of claim 1, further comprising a rubber type coating to increase the friction of the spring clip device.
